(19) United States
(12) Patent Application Publication
(10) Pub. No.: US 2026/0360127 A1
(43) Pub. Date: Nov. 12, 2026

(54) COMPOSITE CONTINUOUS DISCRETE DIFFUSION

(71) Applicant: QUALCOMM Incorporated, San Diego, CA (US)

(72) Inventors: Risheek Garrepalli, San Diego, CA (US); Shreya Kadambi, San Diego, CA (US); Shubhankar Mangesh Borse, San Diego, CA (US); Munawar Hayat, San Diego, CA (US); Fatih Murat Porikli, San Diego, CA (US)

(21) Appl. No.: 19/363,282

(22) Filed: Oct. 20, 2025

Related U.S. Application Data
(60) Provisional application No. 63/803,326, filed on May 9, 2025.

(51) Int. Cl. G06V 10/774; G06T 11/00; G06V 10/20

(52) U.S. Cl. CPC G06V 10/774; G06T 11/00; G06V 10/20

(57) ABSTRACT

A method for composite continuous discrete diffusion includes: applying noise, in a first step, to a first state of an image to generate a second state of the image, wherein the first state of the image comprises a clean state and the second state comprises a noisy state; performing, in a second step, a stochastic transition from the second state of the image to a third state, including selective application of a mask to regions of the second state of the image; continuously repeating the first step and the second step at different time instances to generate a fourth state of the image, wherein the first step is repeated with intermediate states and with increased variance over time and wherein the fourth state comprises a final corrupted state of the image; and training a visual generative model to transform the fourth state back to the first state.

This application claims the benefit of U.S. Provisional Application No. 63/803,326, filed May 9, 2025, the entire contents of which are hereby incorporated by reference.

### TECHNICAL FIELD

This disclosure relates to systems for image editing.

### BACKGROUND

Visual generative models may offer powerful and intuitive ways to manipulate existing images or create new ones based on various forms of input. Instead of relying on traditional pixel-level manipulations, these models may leverage their learned understanding of image distributions to perform more sophisticated and context-aware edits. In general, two different generative modeling paradigms include diffusion/flow matching models and autoregressive generation models. Diffusion models, for example, may learn to reverse a gradual noising process. Starting with a data sample, noise may be progressively added until it becomes pure noise. The diffusion model may then be trained to predict the “next step” in the reverse process-how to denoise the slightly noisy data to get closer to the original.

Image editing is useful in a wide variety of scenarios. For example, synthetic data generation for training deep models, such as, but not limited to, augmenting traffic scenes data, may be used in vehicle assistance systems (e.g., an advanced driver assistance system (ADAS)). In another example, image editing and/or image manipulation may be used for extended reality (XR), such as mixed reality (MR) or augmented reality (AR). In another example, image editing may be used in 3D editing applications.

### SUMMARY

In general, this disclosure describes techniques for adaptively training visual generative models. Training a visual generative model may be difficult for several reasons. For example, pixels in an image are not independent; pixels may have complex spatial and semantic relationships. Capturing these long-range dependencies may be important for generating coherent objects and scenes In another example, traditional convolutional neural networks (CNNs) may struggle with very long-range dependencies, necessitating the use of attention mechanisms and more sophisticated architectures. As a result of these challenges, there may be a need to use semantic context awareness for training the visual generative models to account for semantically inconsistent generations. However, there may be some challenges in learning the contextual relationships between different parts of the image.

The techniques of this disclosure address these challenges. As described herein, the training techniques of this disclosure after the addition of Gaussian noise, which is typically used in continuous diffusion models, may introduce a discrete form of corruption by masking out specific pixels and/or tokens (a group of pixels) of the input image. The visual generative model trained in accordance with one or more techniques described herein may potentially combine the global coherence and high-fidelity generation capabilities of continuous diffusion models with the local context understanding and semantic awareness fostered by masked reconstruction objectives, as discussed below. The masked reconstruction aspects may encourage the visual generative model to learn inter-token dependencies and semantic relationships.

In one example, a system for composite continuous discrete diffusion includes: a storage system comprising one or more computer-readable media, the storage system configured to store one or more images; and a processing system comprising one or more processors implemented in circuitry, the processing system being configured to: apply noise, in a first step, to a first state of an image to generate a second state of the image, wherein the first state of the image comprises a clean state and the second state comprises a noisy state; perform, in a second step, a stochastic transition from the second state of the image to a third state, including selective application of a mask to one or more regions of the second state of the image, wherein the third state comprises a masked state; continuously repeat the first step and the second step at different time instances to generate a fourth state of the image, wherein the first step is repeated with intermediate states and with increased variance over time and wherein the fourth state comprises a final corrupted state of the image; and train a visual generative model to transform the fourth state of the image back to the first state of the image with a denoising score matching objective and an iterative generation process within a diffusion probabilistic modeling framework.

In another example, a method for composite continuous discrete diffusion includes: applying noise, in a first step, to a first state of an image to generate a second state of the image, wherein the first state of the image comprises a clean state and the second state comprises a noisy state; performing, in a second step, a stochastic transition from the second state of the image to a third state, including selective application of a mask to one or more regions of the second state of the image, wherein the third state comprises a masked state; continuously repeating the first step and the second step at different time instances to generate a fourth state of the image, wherein the first step is repeated with intermediate states and with increased variance over time and wherein the fourth state comprises a final corrupted state of the image; and training a visual generative model to transform the fourth state of the image back to the first state of the image with a denoising score matching objective and an iterative generation process within a diffusion probabilistic modeling framework.

In yet another example, a device for image editing includes: one or more memories configured to store one or more images; and processing circuitry coupled to the one or more memories and configured to perform image editing tasks, wherein to perform the image editing tasks, the processing circuitry is configured to: obtain a prompt and an image; and edit the image based on the prompt using a trained visual generative model, wherein the visual generative model is trained using composite continuous discrete diffusion.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example system according to techniques of this disclosure.

FIG. 2A is a diagram illustrating continuous diffusion training paradigm in accordance with one or more techniques of this disclosure.

FIG. 2B is a diagram illustrating masked/discrete diffusion training paradigm in accordance with one or more techniques of this disclosure.

FIG. 3 is a diagram illustrating a combined continuous discrete diffusion training paradigm in accordance with one or more techniques of this disclosure.

FIG. 4 is a flowchart illustrating an example method according to techniques of this disclosure.

### DETAILED DESCRIPTION

Training a visual generative model may be challenging for several reasons. A good visual generative model should not only produce visually realistic images but also ensure that the generated content is semantically meaningful (e.g., objects are placed logically, have consistent properties). Achieving semantic coherence may require the visual generative model to learn high-level concepts and their relationships, which may be difficult with purely pixel-level training.

This disclosure describes techniques that may help to address these challenges. A computing system may store a dataset of one or more images that will be used to train a visual generative model. The computing system may take a first state of an image, which is the clean state (the original, uncorrupted image). The computing system may apply noise to this clean state. This step may be similar to a continuous diffusion process, typically involving adding Gaussian noise with increasing variance over time. The result may be a second state of the image, which may be a noisy state. This state may represent a partially corrupted version of the original image. Additionally, the computing system may take the second state of the image (the noisy state) and may perform a stochastic transition to a third state by selectively applying a mask to one or more regions of the noisy state. Stochastic here implies that the application of the mask may involve some randomness, such as the location or size of the masked regions being probabilistically determined. The third state of the image is a masked state, where certain parts of the noisy image may now be missing or have their information removed (e.g., set to a constant value). This may introduce a discrete corruption element. The computing system may then continuously repeat the first step (noise application) and the second step (masking) at different time instances. In other words, over a series of steps, the image may undergo a gradual corruption process involving both the continuous addition of noise and the discrete removal of information through masking. This repeated process may lead to a fourth state of the image, which may be the final corrupted state. This state may represent the image after multiple stages of both continuous and discrete degradation. The image in the fourth state may be significantly different from the original clean image.

The computing system may use the generated pairs of (final corrupted state, clean state) to train a visual generative model. The objective of this visual generative model may be to learn the inverse process: to transform the fourth state of the image (the final corrupted state) back to the first state of the image (the original clean state). The visual generative model may learn to reverse both the continuous noise and the discrete masking operations, effectively learning to denoise and inpaint the image simultaneously, as described below. In essence, the computing system may define a unique way to corrupt images during the training of a visual generative model. The computing system may combine the continuous degradation of standard diffusion models with a discrete degradation step through selective masking. By exposing the visual generative model to different types of corruption (continuous noise and discrete missing information), the visual generative model may learn more generalizable and robust denoising and inpainting capabilities. The masking may encourage the visual generative model to infer missing information based on the surrounding noisy context, potentially leading to a better understanding of image semantics.

The masked reconstruction objective may encourage the visual generative model to learn contextual relationships and semantic dependencies between different parts of the image, addressing a potential limitation of purely continuous diffusion models. Masked diffusion may excel at learning local dependencies. Combining masked diffusion with the global structure learning of continuous diffusion may lead to more coherent and detailed image generation.

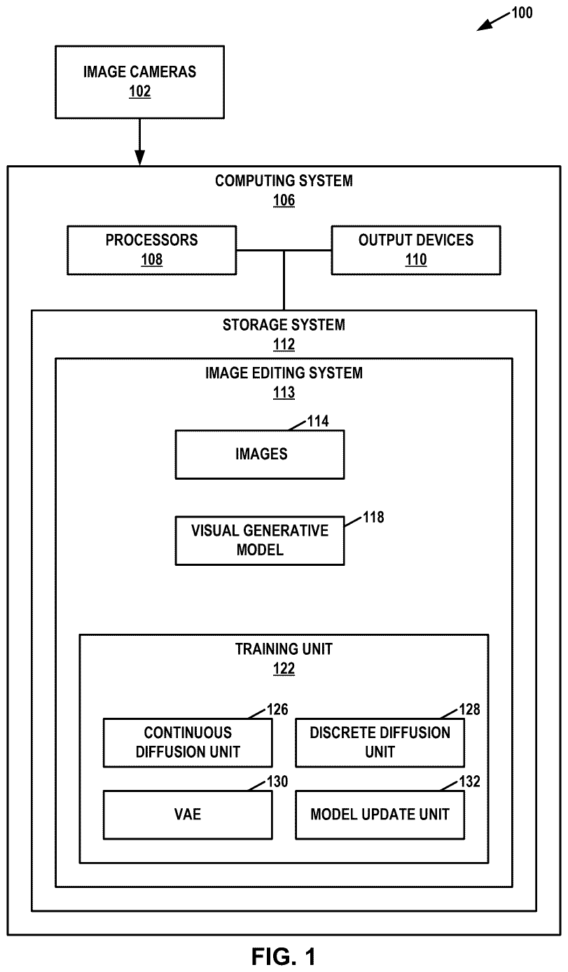

FIG. 1 is a block diagram illustrating an example system 100 according to techniques of this disclosure. In various examples, system 100 may be part of a vehicle, smartphone, mobile device, computing device, robot, or other type of device. In the example of FIG. 1, system 100 includes a plurality of image cameras 102 and a computing system 106. Computing system 106 may include one or more computing devices, such as personal computers, chipsets, mobile devices, or other types of devices.

Image cameras 102 may be configured to generate image data, such as Red-Green-Blue (RGB) images or images in other color spaces. Image cameras 102 may be positioned at various locations around system 100. For instance, in an example where system 100 is a vehicle, image cameras 102 may include two or more forward-facing image cameras, two or more rear-facing image cameras, and so on.

In the example of FIG. 1, computing system 106 includes one or more processors 108, one or more output devices 110, and a storage system 112. Processors 108 may be implemented in circuitry. Example types of processors 108 may include microprocessors, digital signal processors, application-specific integrated circuits (ASICs), and so on. Output devices 110 may include display screens, XR display devices, and other devices for displaying output. In some examples, such as examples involving robotics or driver assistance systems, output device 110 may include actuators to perform various physical actions. Storage system 112 may include one or more non-transitory computer-readable storage media. Example types of non-transitory computer-readable storage media may include random access memory (RAM) units, disk drives, and so on. Processors 108, output device 110, and the computer-readable storage media of storage system 112 may be distributed among two or more devices of computing system 106, or may be consolidated within a single device of computing system 106.

Storage system 112 may be configured to store various types of data and computer-readable instructions. In the example of FIG. 1, storage system 112 stores data and instructions associated with an image editing system 113, such as images 114 generated by image cameras 102. Additionally, visual editing system 113 may also store a visual generative model 118. Visual generative model 118 may include data defining a model for generating and editing images. While images are the most common form of visual data generated by visual generative model 118, visual data may include other modalities, such as, but not limited to: videos, 3D models, animations and any other forms of visual representations. In examples where visual generative model 118 is implemented using one or more artificial neural networks, the visual generative model 118 may include input weights for parameters.

Storage system 112 may store computer-readable instructions of visual editing system 113 associated with training unit 122. Processors 108 may execute instructions of training unit 122. Execution of instructions associated with training unit 122 may configure processors to perform the functionality ascribed in this disclosure to training unit 122. Thus, when this disclosure indicates that training unit 122 (or sub-units thereof) perform specific actions, this may be the result of processors 108 executing instructions associated with training unit 122. In other examples, specific actions described in this disclosure as being performed by training unit 122 (or sub-units thereof) may be performed by special purpose circuitry.

Training unit 122 may perform a process to adaptively train visual generative model 118. Training visual generative model 118 may improve the ability of visual generative model 118 to accurately learn contextual relationships and semantic dependencies between different parts of the image. In the example of FIG. 1, training unit 122 includes a continuous diffusion unit 126, a discrete diffusion unit 128, an optional Variational AutoEncoder (VAE) unit 130, and a model update unit 132.

As noted above, the two dominant paradigms that have significantly shaped the landscape of visual generative models are diffusion models and autoregressive models. Diffusion models may learn to reverse a gradual noising process. Diffusion models may start with a data sample (an image), such as images 114, and may progressively add noise until the data sample becomes pure random noise, and then the diffusion model may learn to reverse this process to generate new samples from noise. Typically, diffusion models may predict the noise added at each step or the score (gradient of the data density). In some examples, diffusion models have demonstrated the ability to generate high-quality and photorealistic images, often surpassing the quality of Generative Adversarial Networks (GANs) in recent years.

Diffusion models tend to produce a diverse range of samples. Training of diffusion models may be more stable compared to adversarial training in GANs. While initially focused on unconditional generation, significant progress has been made in conditioning diffusion models on text, layout, semantic maps, and other modalities, leading to increased controllability. The inherent process of iterative refinement in diffusion makes such models well-suited for tasks like image inpainting (filling in missing or unwanted regions of an image), outpainting (extending an image beyond original boundaries), and text-guided editing by manipulating the noise or intermediate denoising steps.

Drawing inspiration from the success of autoregressive models in natural language processing (like GPT), autoregressive modeling paradigm may treat image generation/editing as a sequential prediction task. Instead of predicting the next word, the autoregressive models may predict the next “visual token” or element conditioned on the previously generated ones. To work with visual tokens, images, such as images 114, may need to be first discretized into a sequence of tokens. Conceptually speaking, tokenization may often be achieved using techniques like Vector Quantization (VQ-VAE) which may compress the image into a discrete latent space. Similar to Large Language Models (LLMs), autoregressive models may be trained to predict the next token in the sequence given the preceding tokens using a transformer architecture. Autoregressive models may excel at capturing long-range dependencies and contextual information, which could lead to more semantically coherent and globally consistent image generation. In general, the sequential nature may offer fine-grained control over the generation process. By manipulating the initial tokens or the generation trajectory, one could potentially guide the output more precisely. In general, editing could be framed as manipulating the sequence of visual tokens. In some examples, masking out a portion of the sequence and having the trained model inpaint that sequence, or conditioning the generation on specific initial tokens to guide the style or content may be helpful. Both diffusion and autoregressive approaches have their own strengths and weaknesses regarding controllability and editing. While achieving high quality, early diffusion models were less inherently controllable.

However, recent advancements in conditional diffusion have significantly improved diffusion models. In general, iterative nature of diffusion models may lend itself well to certain editing tasks. Autoregressive models may offer strong contextual understanding and potential for precise control due to their sequential nature. For example, editing may be considered as a sequence manipulation. However, generating high-fidelity, continuous visual data from discrete tokens may be challenging.

Current visual generative models, particularly when faced with complex editing instructions, may lack a robust ability for visual grounded manipulation. For example, current visual generative models may struggle to identify and understand which parts of a reference image (or multiple images) are relevant to different aspects of the text prompt. Such models may also struggle to modify the identified visual elements according to the nuances of the text instruction without causing unwanted changes elsewhere. In addition, current visual generative models may struggle to seamlessly integrate the changes into the existing visual context, maintaining visual harmony and semantic consistency. As a result, edits may look unnatural or poorly integrated with the original image. The manipulated elements may not align logically with the rest of the scene or the overall context. The current visual generative models may make global changes instead of the specific, localized edits requested. When the instruction implies drawing visual features from different reference images (guided by text), current visual generative models may struggle to extract and combine these elements effectively.

This deficiency in visual grounded manipulation and coherent composition may be partly due to the limitations of the current training objectives. For instance, standard training objectives may not explicitly incentivize the visual generative model 118 to learn to independently control and manipulate different visual aspects of an image.

Additionally, standard training objectives may not explicitly incentivize the visual generative model 118 to develop a strong grounding between language and visual features. Thus, current generative models trained using current training objectives may struggle to focus changes on the relevant regions while preserving the integrity of the rest of the image. Current training objectives may also prevent the visual generative model 118 from understanding how different visual elements should be combined to create a realistic and semantically sound output.

In some examples, the disclosed techniques of dual corruption (Gaussian noise+masking) discussed below combined with a masked reconstruction objective may directly tackle the aforementioned limitations. The training unit 122 may be configured to bridge these two paradigms to harness their complementary benefits for improved base generation quality and, importantly, enhanced controllability and editing capabilities for various downstream use cases. Training unit 122 may train visual generative model 118 with objectives that may incorporate principles from both diffusion and autoregressive learning (using, for example, dual corruption techniques discussed below). The discrete diffusion unit 128 employing the masked/discrete objective may encourage the visual generative model 118 to understand the context of the unmasked regions when trying to reconstruct the masked portions. In another non-limiting example, discrete diffusion unit 118 may encourage the visual generative model 118 to predict missing visual information based on the context of the remaining (noisy) parts of the image. In this example, the discrete diffusion unit 128 may implicitly teach the visual generative model 118 to ground visual elements and understand relationships of such elements. For example, this inherent contextual understanding may be important for realistic and coherent image editing. For instance, when users want to edit a specific part of an image based on a text prompt (e.g., “change the color of the car”), the visual generative model 118 may need to understand the shape of the surroundings of the car, and how the requested change should integrate into the existing scene. Furthermore, the continuous diffusion unit 126 may provide a strong learning framework for generating high-fidelity details and better ensuring overall image quality during the editing process. The iterative denoising framework may smoothly integrate the edits into the original image.

For example, by conditioning the diffusion and masked reconstruction process on the original image 114 and the editing instructions (e.g., text, masks), training unit 122 may guide the visual generative model 118 in learning how to make specific and localized changes rather than generating a completely new image. In multi-turn editing example, where a user makes a series of modifications to an image, maintaining consistency across edits may be important. Additionally, the ability of the visual generative model 118 to understand context and reconstruct masked regions based on the existing (and potentially already edited) parts of the images 114 may help better ensure that subsequent edits are coherent with the previous ones.

For example, the diffusion portion of the disclosed combined dual corruption forward process that may be performed by continuous diffusion unit 126 may naturally lend itself to iterative refinement. Each editing step may be considered as a guided denoising process that incorporates the new instructions while preserving relevant aspects of the previously edited image. The discrete diffusion unit 128 may further help in learning focusing the changes on the desired regions.

While focus of the visual generative model 118 may be on images 114, the principles of context understanding and coherent manipulation may potentially extend to video editing. By treating video frames as a sequence and incorporating temporal masking or conditioning, the visual generative model 118 may be able to perform edits that are temporally smooth and consistent. Learning to understand the context of objects across frames (a form of spatiotemporal awareness) could be facilitated by the discrete diffusion unit 128, allowing for consistent manipulation of objects throughout a video.

The semantic awareness gained through, for example, reversed discrete/masked diffusion, may significantly enhance the ability of the visual generative model 118 to understand and execute text-based editing instructions. In this example, the visual generation model 118 may learn relationships between visual elements and their potential textual descriptions. Text prompts often refer to specific objects or attributes. For example, the discrete diffusion unit 128 may help the visual generative model 118 learn to focus editing efforts on the relevant regions guided by the textual context. When guided by text, the visual generative model 118 may learn to associate textual descriptions with specific visual regions and their manipulations. Thus, in some examples, by masking specific tokens or regions, training unit 122 may essentially train the visual generative model 118 to perform localized reconstructions. In some examples, this may translate to more targeted editing when conditioned on text or masks.

The visual generative model 118 may learn to generate plausible content to fill in the masked regions, conditioned on the surrounding context. This experience in “filling in” missing information in a visually coherent way may lead to better composition when performing edits.

A dominant trend in the recent years has been the development of highly specialized models through fine-tuning large, pre-trained diffusion models (like stable diffusion models) on specific datasets and benchmarks. Various specific models or techniques may be tailored for particular editing tasks, often evaluated on curated datasets. In other examples, these fine-tuned models may achieve very good results on their target benchmarks, demonstrating superior performance for those specific editing scenarios (e.g., high-quality inpainting, precise object manipulation).

In these examples the performance gains may be tightly coupled to the specific characteristics and biases of the fine-tuning datasets. It may be impractical having a separate, large-scale model for every conceivable image editing application. Deploying and maintaining numerous distinct models on resource-constrained devices (like smartphones or embedded systems) may present significant challenges in terms of storage, memory, and computational power.

Furthermore, models fine-tuned on very specific datasets may not generalize well to other editing tasks or real-world images that deviate from the training data. Requiring users to download and manage multiple specialized models for different editing needs may lead to a fragmented and cumbersome user experience. In other words, there is a need to move towards more general-purpose models that may handle a wider range of editing tasks and instructions without requiring task-specific fine-tuning. The training unit 122 may be configured to build more of a generalist visual generative model 118 with a stronger understanding of visual context and the ability to perform grounded manipulations based on instructions, may directly address this challenge.

Additionally, by training the visual generative model 118 to focus on fundamental capabilities like understanding relationships between visual elements and text, and composing them effectively, the training unit 122 may train the visual generative model 118 that may generalize across various editing tasks. A model with strong visual grounding and manipulation skills should be more adaptable to new editing instructions and unseen data without requiring extensive fine-tuning on task-specific datasets.

There is a growing interest in developing generalist models that may handle a wide variety of visual tasks—including different types of image generation, editing, and potentially even other vision tasks-within a single framework. This ambition mirrors the trend in natural language processing where large language models are being adapted for diverse downstream applications through prompting and fine-tuning, rather than requiring separate specialized models for each task. The potential benefits of a generalist visual model may be significant, including, but not limited to, reduced model proliferation, simplified deployment, and the possibility of knowledge transfer across different tasks.

The pursuit of generalist models may be somewhat independent of the fundamental generative paradigm (diffusion-based, autoregressive, or potentially others). The goal of handling multiple tasks may be applied to models built on any of these core architectures. Advantageously, the disclosed system is primarily focused on the training objective itself, regardless of whether the underlying model architecture is based on continuous diffusion, a hybrid approach, or even an autoregressive framework adapted for visual generation.

As discussed above, conventional stable diffusion style objective may involve training the model to reverse a gradual noising process. The model may learn to predict the noise added at each step or the score function, enabling the diffusion model to generate images by iteratively denoising from random noise. Such training typically requires large datasets of images.

In summary, the traditional diffusion training objective has proven ability to generate high-fidelity and diverse images. This training objective may be effective for tasks like text-to-image generation, image variation, and certain editing tasks (especially those that can be framed as guided denoising). However, the standard diffusion training objective may not inherently instill a strong sense of visual grounding and compositional reasoning needed for intricate, instruction-based manipulations. Inspired by the training of LLMs, the token prediction training objective may treat image generation as a sequential prediction of discrete visual tokens. In an example, visual generative model 118 may be trained on sequences of visual tokens representing a large corpus of images. The sequential nature and the strong contextual understanding inherent in transformer architectures could offer advantages for precise control and manipulation. Editing may be interpreted as manipulating the sequence of visual tokens. However, generating high-fidelity, continuous visual details from a discrete token sequence may be challenging with this training objective alone.

Advantageously, the disclosed training techniques involve a dual corruption strategy during the forward diffusion process. The training module may take a clean reference image and may apply a degree of Gaussian noise (the standard diffusion corruption). The visual model may be trained to predict a slightly less noisy version of this noisy image. This aligns with the denoising objective of traditional diffusion models. In addition, the training module may apply a masking operation (removing some of the visual “tokens” or regions). This mirrors the corruption process in masked autoencoders or masked language models, which are related to the next-token prediction paradigm in visual generation. This additional operation may help to train the model to predict a slightly less masked version of this masked image (i.e., to reconstruct some of the missing information). It should be noted that both prediction targets, “slightly less noisy” and “slightly less masked,” share a common underlying principle: the model may learn to recover information that was intentionally removed during the corruption process. The noise corruption may remove information in a continuous, spectral sense. The visual generative model may learn to gradually recover this lost information by denoising. The masking corruption may remove information in a discrete, spatial (or token-based) sense. The visual model may learn to recover this lost information by inferring the missing content from the visible context. By training the visual model to perform both of these recovery tasks simultaneously, the training unit may equip the visual model with the ability to generate high-fidelity details and overall coherent structure (from the diffusion branch). In addition, the visual model may be equipped with a strong understanding of contextual relationships and semantic dependencies (from the masked prediction branch), which may be important for visual grounding and coherent manipulation.

Advantageously, the disclosed training objective involves a dual corruption strategy during the forward diffusion process. The training unit 112 may take a clean reference image, for example one of images 114 and may apply a degree of noise (e.g., Gaussian noise). In turn, the visual generative model 118 may be trained to predict a slightly less noisy version of this noisy image. This aspect of the disclosed training objective aligns with the denoising objective of traditional diffusion models. However, in addition, the training unit 112 may apply a masking operation (removing some of the visual tokens or regions). This mirrors the corruption process in masked autoencoders or masked language models, which are related to the next-token prediction paradigm in visual generation. This additional operation may help to train the visual generative model 118 to predict a slightly less masked version of this masked image (i.e., to reconstruct some of the missing information). It should be noted that both prediction targets, “slightly less noisy” and “slightly less masked,” share a common underlying principle: the visual generative model 118 may learn to recover information that was intentionally removed during the corruption process. The noise corruption may remove information in a continuous, spectral sense. The visual generative model 118 may learn to gradually recover this lost information by denoising. The masking corruption may remove information in a discrete, spatial (or token-based) sense. In turn, the visual generative model 118 may learn to recover this lost information by inferring the missing content from the visible context. By training the visual generative model 118 to perform both of these recovery tasks simultaneously, the training unit 122 may equip the visual generative model 118 with the ability to generate high-fidelity details and overall coherent structure (from the diffusion objective). In addition, the visual generative model 118 may be equipped with a strong understanding of contextual relationships and semantic dependencies (from the masked prediction objective), which may be important for visual grounding and coherent manipulation.

Model update unit 132 may train visual generative model 118 based on the dual corruption training objective.

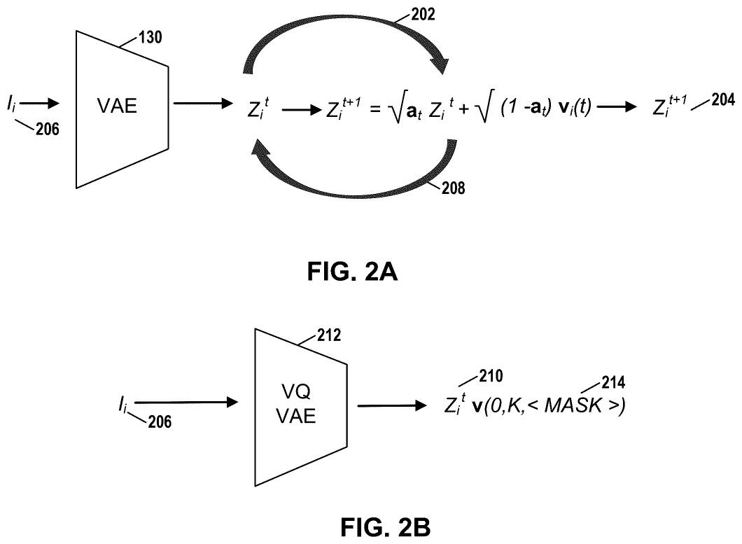

FIG. 2A is a diagram illustrating continuous diffusion training paradigm in accordance with one or more techniques of the disclosure. In FIG. 2A, the arrow 202 may represent the forward diffusion process performed based on the probability distribution. In one non-limiting example, q(zₜ₊₁|zₜ) may represent the conditional probability distribution of the noisy latent variable zₜ₊₁ at time step t+1 given the latent variable zₜ at time step t. The equation 204 may represent the continuous diffusion where:
zᵢ^{t} may be the latent representation of the input image 206 at time step t in the forward diffusion process;
αₜ may be a variance schedule parameter between 0 and 1, controlling the amount of noise added at each step and \sqrt{αt} may scale down the original signal;
Iᵢ may be the reference image (input image 206);
1−αₜ may represent the variance of the added Gaussian noise at time step t.
   This equation 204 shows that in the forward process of continuous diffusion depicted as arrow 202, the next noisy state zᵢ^{t+1} may be obtained by taking the previous state zit scaling it down, and adding Gaussian noise with a variance controlled by (1−αₜ). The visual generative model 118 may then learn the reverse process based on p_{θ}(zₜ₋₁|zₜ)=N(zₜ₋₁;u_{θ}), aiming to predict a less noisy version zₜ₋₁ from the current noisy state zₜ of the original input image 206. N may represent a Gaussian distribution with mean μ. The reverse process is depicted in FIG. 2A by arrow 208.

FIG. 2B is a diagram illustrating masked/discrete diffusion training paradigm in accordance with one or more techniques of this disclosure. As noted above, the zero-shot inpainting performance of masked diffusion may arise from the nature of the prediction objective. In other words, in this training paradigm, the visual generative model 118 may be trained to predict missing information. FIG. 2B also illustrates the concept of a discrete latent space and a codebook. The term 210 in FIG. 2B may indicate that the latent representation zᵢ^{t}. In this training paradigm, any given diffusion step may consist of tokens drawn from a discrete vocabulary. This vocabulary may include a set of K+1 discrete codes representing visual features learned by a vector quantization (VQ) process performed by VQ VAE 212 or a similar discretization technique. Each of these codes may be associated with an entry in a codebook. The <MASK> token 214 may be a special token representing a masked-out or missing part of the input image 206. The codebook may act as a lookup table where each discrete code may be mapped back to a continuous visual representation (e.g., a vector or a patch of pixels). It should be noted that the discrete diffusion training paradigm may be associated with the discrete diffusion objective described above. In an example, the discrete diffusion objective may incorporate the specific loss function or training signal that may drive the discrete diffusion process. This objective may, for example, define how the discrete tokens may be progressively corrupted (e.g., by randomly replacing tokens with the <MASK> token 214 or transitioning between other discrete codes). The reverse process may constitute learning. In other words, the training unit 122 may train the visual generative model 118 to predict the original (less corrupted) sequence of discrete tokens from the corrupted sequence. This prediction may involve estimating the probability distribution over the possible next tokens or directly predicting the uncorrupted token. In one example, the training unit 122 employing the discrete diffusion technique may train the visual generative model 118 to classify the original token given the corrupted context. In another example, the discrete diffusion may model the probability of transitioning from a corrupted state back to a less corrupted state. In yet another example, the discrete diffusion may adapt the score matching principle to the discrete domain. By training with a discrete diffusion objective that involves predicting masked tokens in a discrete latent space, the visual generative model 118 may learn a representation of visual information in terms of discrete tokens (via the codebook). To predict a masked token, the visual generative model 118 may need to understand the relationships between the surrounding (unmasked) tokens.

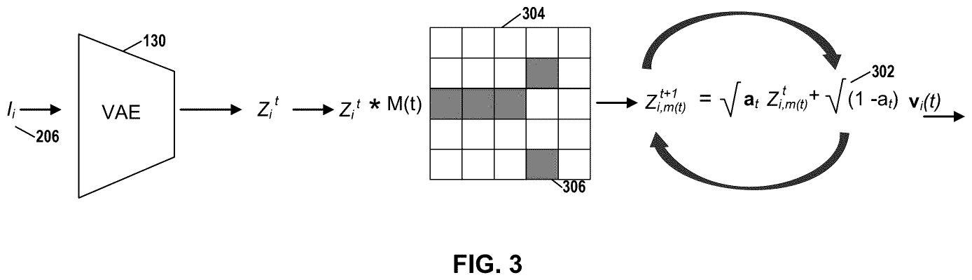

FIG. 3 is a diagram illustrating a combined continuous discrete diffusion training paradigm in accordance with one or more techniques of this disclosure. In the example of FIG. 3, the training unit 122 may start with a clean, ground truth input image 206 (the target that the visual generative model 118 may need to learn predict or reconstruct). In an example illustrated in FIG. 3, the training unit 122 may generate discrete latent space by feeding the original input image 206 into the VAE 130. In an aspect, the dual corruption forward process illustrated in FIG. 3 may incorporate elements of both continuous diffusion corruption and masked token corruption. At each time step t, the training module may sample either from the continuous diffusion or discrete diffusion, using the following formula:

$${z}_{t} = \{ \begin{matrix}{z}_{t} & \sim N ( {z}_{0} , {μ}_{, t} {\sum }_{t} ) \\ {z}_{t} & = < mask >\end{matrix}$$

where z₀ may represent the initial clean latent representation of the image; μₜ and Σₜ may be the mean and covariance of the noise distribution at timestep t in the continuous diffusion process. Then training unit 122 may generate the next noisy state using the equation 302 shown in FIG. 3. In the equation 302, at may be the noise schedule parameter. The ϵᵢ(t) may be a sample of Gaussian noise. This step may degrade the already noisy latent zₜ further with more Gaussian noise. In an example, instead of following the continuous diffusion forward process, with a probability of (1−p), the training unit 122 may directly set the latent vector zₜ to a masked state (zₜ=<mask>). Here, <mask> may represent a latent vector with a fixed embedding that may signify a masked token, such as <MASK> token 214. The process illustrated in FIG. 3 introduces a stochastic element to the forward diffusion. At each step, the training unit 122 may perform either a gradual Gaussian noise addition (the standard diffusion path) to the current state of the image or a direct transition of the current state of the image to a masked state. By training the visual generative model 118 reverse process to predict z₀ from both noisy states (obtained through standard diffusion) and masked states, the training unit 122 may encourage the visual generative model 118 to learn both denoising (recovering from Gaussian noise) and inpainting (recovering missing information represented by the <mask> token). The probability p may allow the training unit 122 to control the frequency with which the visual generative model 118 may encounter purely noisy states versus masked states during training. This could be a configurable parameter of the training unit 122 to tune the balance between the diffusion and masked reconstruction capabilities of the visual generative model 118. Using a fixed embedding for the <MASK> token 214 may simplify the learning process for the visual generative model 118 to recognize and reconstruct missing information. During the encoding process, the continuous latent vector for each spatial location may be quantized by finding the closest embedding vector in the codebook, and only the index of this closest vector may be retained as the discrete representation. As a result, the input image 206 may be represented by a grid 304 of these discrete indices (tokens).

In other words, the training unit 122 may create a noisy version of this input image 206. The training unit 122 may be operating in a discrete latent space (after tokenization) or applying noise locally to image patches. This noisy version of the input image 206 may represent the state after some steps of the forward diffusion process. On top of this already noisy version of the tokens, the training unit 122 may introduce an additional layer of corruption by masking out certain tokens or regions (e.g., dark regions 306). In other words, in the grid 304 some information has been removed entirely, while the remaining information is still noisy. Despite this dual corruption (both noise and masking), the prediction target for the visual generative model 118 remains the same, clean ground truth input image 206. In essence, the visual generative model 118 is learning to recover the clean input image 206 from a state of the image that has undergone two forms of degradation. Some information may have been blurred or obscured by noise, such as, but not limited to Gaussian noise. Some information may have been completely removed with masking. By training the visual generative model 118 to reconstruct the clean input image 206 even when parts are missing and the remaining parts are noisy, the training unit 122 may encourage the visual generative model 118 to be robust to both types of information loss. This could be particularly beneficial for editing scenarios where parts of an image may be occluded or need to be filled in from a noisy context. To accurately reconstruct the masked-out regions (e.g., dark regions 306 in the grid 304) from the noisy surroundings, the visual generative model 118 may need to develop a strong understanding of the contextual relationships between different parts of the image, even in the presence of noise.

In this example, the training unit 112 may sample an intermediate noisy state by drawing from a Gaussian distribution N(z₀,μₜ Σₜ). The training unit 112 may control the magnitude of the noise (ϵ) added to the original image or latent z₀ to obtain the intermediate noisy state. The training unit 112 may then generate a binary mask M (implicitly M(t) as it can vary per timestep). This mask may be the same dimensionality as the input image 206 or latent representation. Next, for each pixel or token in the intermediate noisy state, the training unit 112 may decide whether to mask that pixel/token out or keep its original value based on the mask M. In an example, this decision may be drawn from a Bernoulli distribution (or a similar probabilistic process). In other words, each pixel/token may have a certain probability of being masked independently. The final corrupted state that the visual generative model 118 will learn to reverse from may be a combination of these two processes: it may be a noisy version of the original input image 206 with some of its pixels or tokens randomly masked out. Importantly, this dual process may create a more complex and perhaps more realistic form of corruption compared to just adding Gaussian noise or just applying a mask. Real-world data may often have both noise and missing information. Advantageously, training the visual generative model 118 to recover the original input image 206 from this doubly corrupted state should make the visual generative model 118 more robust to various types of degradation. The Gaussian noise may teach the visual generative model 118 to learn global image structure and denoise effectively. The random masking may teach the visual generative model 118 to learn local contextual dependencies to fill in missing information. This type of corruption may closely mirror the challenges in many image editing tasks. Inpainting may require filling in masked regions. Some parts of a noisy image may be completely missing or unreliable.

The conventional diffusion process may typically train the visual generative model 118 to predict a slightly less noisy version of a noisy input. The loss may be based on the difference between the predicted denoised state and a less noisy target. In contrast, the disclosed dual corruption training technique may train the visual generative model 118 to predict the clean target (or a less noisy/less masked target) from an input that is both noisy and partially masked. This may encourage the visual generative model 118 to learn to handle both types of degradation simultaneously.

As used herein, αₜ may govern the balance between the original, clean information and the added noise in the intermediate noisy state of the image. This is a standard aspect of diffusion model training schedules. The example of training unit 122 illustrated in FIG. 1, for computational efficiency, may perform the dual forward diffusion process (including the aforementioned dual corruption) in a compressed latent space, which may be obtained using the VAE 130 or a similar dimensionality reduction technique. This technique may reduce the computational cost of processing high-resolution images directly in pixel space. Importantly, the core idea of the disclosed dual corruption training objective may be orthogonal to the choice of working in latent space or pixel space. The concept of applying both Gaussian noise and masking to the data during the forward process and training the visual generative model 118 to reconstruct the original input image 206 may be implemented regardless of the underlying representation. In other words, the disclosed training strategy may not be tied to a specific architectural choice (like using the VAE 130). This training strategy may potentially be applied to diffusion models operating directly in pixel space or those using other forms of latent representations.

It should be noted that the training unit 112 may perform the initial transformation from pixel space to a lower-dimensional space primarily for computational efficiency. This transformation may be essentially a downsampling operation that may reduce the spatial dimensions of the data, making the subsequent diffusion process more manageable. As shown in FIG. 2B, the VQ-VAE 212 may introduce an important element of discretization to the latent space. Instead of continuous latent vectors for each spatial location, the VQ-VAE 212 may map each location to a discrete index from a learned codebook. This codebook may contain a finite number of learned embedding vectors. During the encoding process, the continuous latent vector for each spatial location may be quantized by finding the closest embedding vector in the codebook, and only the index of this closest vector may be retained as the discrete representation. As a result, the input image may be represented by the grid 304 of these discrete indices (tokens). For each spatial token in the latent space, the training unit 112 may have one specific, discrete value corresponding to an entry in the codebook. This may be one of the differences from a standard VAE 130, which may produce continuous latent vectors. The discrete nature of the VQ-VAE 212 latent space may have significant implications for how diffusion can be applied. As discussed above, diffusion in a discrete space may involve modeling transitions between these discrete tokens over time. The forward process may involve randomly changing tokens to other tokens in the codebook or to a special <MASK> token. The reverse process may involve learning to predict the original token distribution. The discrete representation may also lend itself well to autoregressive modeling, where the visual generative model 118 may predict the sequence of discrete tokens one after another, similar to how language models predict the next word. The disclosed dual corruption technique may be adapted to this discrete latent space. The training unit 112 may introduce noise by probabilistically changing discrete tokens to other tokens in the codebook (perhaps based on some learned transition probabilities) or to the <MASK> token.

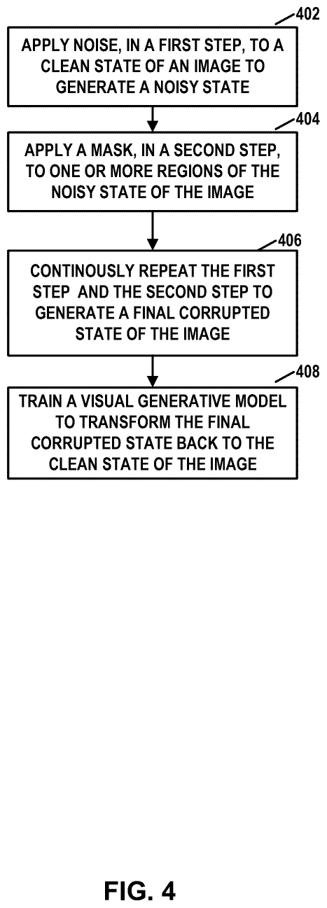

FIG. 4 is a flowchart illustrating an example method according to techniques of this disclosure. In the example of FIG. 4, storage system 112 may store one or more images that may be used to train a visual generative model. Furthermore, continuous diffusion unit 126 may apply noise, in a first step, to a first state of an image to generate a second state of an image (402). The first state of the image may be a clean state and the second state of the image may be a noisy state. In an example, at may be a variance schedule parameter between 0 and 1, controlling the amount of noise added at each step. Discrete diffusion unit 128 may perform, in a second step, a stochastic transition from the second state of the image to a third state by selectively applying a mask to one or more regions of the second state of the image (404). The third state may comprise a masked state. Stochastic here implies that the application of the mask may involve some randomness, such as the location or size of the masked regions being probabilistically determined.

Continuous diffusion unit 126 and discrete diffusion unit 128 may continuously repeat the first step and the second step, respectively, at different time instances to generate a fourth state of the image (406). The first step may be repeated with intermediate states and with increased variance over time. The fourth state may comprise a final corrupted state of the image. In other words, over a series of steps, the image may undergo a gradual corruption process involving both the continuous addition of noise and the discrete removal of information through masking. Model update unit 132 may train visual generative model 118 to transform the fourth state of the image back to the first state of the image (408). Thus, in some examples, by masking specific tokens or regions, training unit 122 may essentially train the visual generative model 118 to perform localized reconstructions. In some examples, this may translate to more targeted editing when conditioned on text or masks. In one example, the trained visual generative model 118 may iteratively and gradually denoise the image. At each step, the visual generative model 118 may predict and remove a small amount of noise and restore some masked information. In one example, the visual generative model 118 may be trained using a denoising score matching objective. In other words, the trained visual generative model 118 may learn to estimate the score function (the gradient of the log density) of the noisy data distribution at each time step. By learning this score, the visual generative model 118 may guide the denoising process in the reverse direction. Through this iterative denoising and demasking process, starting from pure masked noise, the visual generative model 118 may gradually reconstruct a realistic image that resembles the original data distribution (e.g. the original state of the image).

Various examples of the techniques of this disclosure are summarized in the following clauses.

Clause 1. A system for composite continuous discrete diffusion comprising: a storage system comprising one or more computer-readable media, the storage system configured to store one or more images; and a processing system comprising one or more processors implemented in circuitry, the processing system being configured to: apply noise, in a first step, to a first state of an image to generate a second state of the image, wherein the first state of the image comprises a clean state and the second state comprises a noisy state; perform, in a second step, a stochastic transition from the second state of the image to a third state, including selective application of a mask to one or more regions of the second state of the image, wherein the third state comprises a masked state; continuously repeat the first step and the second step at different time instances to generate a fourth state of the image, wherein the first step is repeated with intermediate states and with increased variance over time and wherein the fourth state comprises a final corrupted state of the image; and train a visual generative model to transform the fourth state of the image back to the first state of the image with a denoising score matching objective and an iterative generation process within a diffusion probabilistic modeling framework.

Clause 2. The system of clause 1, wherein the processing system is further configured to: compress the image into a discrete or continuous latent space prior to applying the noise.

Clause 3. The system of clause 2, wherein the processing system configured to compress the image into the discrete or continuous latent space is further configured to: compress the image into the discrete or continuous space using a variational autoencoder.

Clause 4. The system of clause 1, wherein the processing system configured to perform the selective application of the mask is further configured to: determine, for each pixel in an intermediate noisy state, whether to mask the corresponding pixel or keep original value of the pixel based on the mask.

Clause 5. The system of clause 1, wherein the processing system configured to train the visual generative model to transform the fourth state is further configured to: train the visual generative model to transform the fourth state of the image to a less noisy state and less masked state of the image.

Clause 6. The system of clause 5, wherein the processing system configured to train the visual generative model to transform the fourth state of the image to the less noisy state and less masked state of the image is further configured to: train the visual generative model to recover information that was removed from the image during the first step.

Clause 7. The system of clause 1, wherein the processing system configured to train the visual generative model to transform the fourth state is further configured to: train the visual generative model to determine contextual relationships and semantic dependencies between different parts of the image via masked reconstruction.

Clause 8. The system of clause 7, wherein the processing system configured to train the visual generative model to transform the fourth state is further configured to: train the visual generative model to edit a specific part of the image based on a text prompt.

Clause 9. The system of clause 1, wherein the image comprises a video frame.

Clause 10. A method for composite continuous discrete diffusion, the method comprising: applying noise, in a first step, to a first state of an image to generate a second state of the image, wherein the first state of the image comprises a clean state and the second state comprises a noisy state; performing, in a second step, a stochastic transition from the second state of the image to a third state, including selective application of a mask to one or more regions of the second state of the image, wherein the third state comprises a masked state; continuously repeating the first step and the second step at different time instances to generate a fourth state of the image, wherein the first step is repeated with intermediate states and with increased variance over time and wherein the fourth state comprises a final corrupted state of the image; and training a visual generative model to transform the fourth state of the image back to the first state of the image with a denoising score matching objective and an iterative generation process within a diffusion probabilistic modeling framework.

Clause 11. The method of clause 10, the method further comprising: compressing the image into a discrete or continuous latent space prior to applying the noise.

Clause 12. The method of clause 11, wherein compressing the image into the discrete or continuous latent space further comprises: compressing the image into the discrete or continuous latent space using a variational autoencoder.

Clause 13. The method of clause 10, wherein selective application of the mask further comprises: determining, for each pixel in an intermediate noisy state, whether to mask the corresponding pixel or keep original value of the pixel based on the mask.

Clause 14. The method of clause 10, wherein training the visual generative model to transform the fourth state further comprises: training the visual generative model to transform the fourth state of the image to a less noisy state and less masked state of the image.

Clause 15. The method of clause 14, wherein training the visual generative model to transform the fourth state of the image to the less noisy state and less masked state of the image further comprises: training the visual generative model to recover information that was removed from the image during the first step.

Clause 16. The method of clause 10, wherein training the visual generative model to transform the fourth state further comprises: training the visual generative model to determine contextual relationships and semantic dependencies between different parts of the image via masked reconstruction.

Clause 17. The method of clause 16, wherein training the visual generative model to transform the fourth state further comprises: training the visual generative model to edit a specific part of the image based on a text prompt.

Clause 18. The method of clause 10, wherein the image comprises a video frame.

Clause 19. A device for image editing, the device comprising: one or more memories configured to store one or more images; and processing circuitry coupled to the one or more memories and configured to perform image editing tasks, wherein to perform the image editing tasks, the processing circuitry is configured to: obtain a prompt and an image; and edit the image based on the prompt using a trained visual generative model, wherein the visual generative model is trained using composite continuous discrete diffusion.

Clause 20. The device of clause 19, wherein the visual generative model is trained according to the following: apply noise, in a first step, to a first state of a training image to generate a second state of the training image, wherein the first state of the training image comprises a clean state and the second state comprises a noisy state; perform, in a second step, a stochastic transition from the second state of the training image to a third state, including selective application of a mask to one or more regions of the second state of the training image, wherein the third state comprises a masked state; continuously repeat the first step and the second step at different time instances to generate a fourth state of the training image, wherein the first step is repeated with intermediate states and with increased variance over time and wherein the fourth state comprises a final corrupted state of the training image; and train the visual generative model to transform the fourth state of the training image back to the first state of the training image with a denoising score matching objective and an iterative generation process within a diffusion probabilistic modeling framework.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A system for composite continuous discrete diffusion comprising:
a storage system comprising one or more computer-readable media, the storage system configured to store one or more images; and
a processing system comprising one or more processors implemented in circuitry, the processing system being configured to:
apply noise, in a first step, to a first state of an image to generate a second state of the image, wherein the first state of the image comprises a clean state and the second state comprises a noisy state;
perform, in a second step, a stochastic transition from the second state of the image to a third state, including selective application of a mask to one or more regions of the second state of the image, wherein the third state comprises a masked state;
continuously repeat the first step and the second step at different time instances to generate a fourth state of the image, wherein the first step is repeated with intermediate states and with increased variance over time and wherein the fourth state comprises a final corrupted state of the image; and
train a visual generative model to transform the fourth state of the image back to the first state of the image with a denoising score matching objective and an iterative generation process within a diffusion probabilistic modeling framework.

2. The system of claim 1, wherein the processing system is further configured to:
compress the image into a discrete or continuous latent space prior to applying the noise.

3. The system of claim 2, wherein the processing system configured to compress the image into the discrete or continuous latent space is further configured to:
compress the image into the discrete or continuous space using a variational autoencoder.

4. The system of claim 1, wherein the processing system configured to perform the selective application of the mask is further configured to:
determine, for each pixel in an intermediate noisy state, whether to mask the corresponding pixel or keep original value of the pixel based on the mask.

5. The system of claim 1, wherein the processing system configured to train the visual generative model to transform the fourth state is further configured to:
train the visual generative model to transform the fourth state of the image to a less noisy state and less masked state of the image.

6. The system of claim 5, wherein the processing system configured to train the visual generative model to transform the fourth state of the image to the less noisy state and less masked state of the image is further configured to:
train the visual generative model to recover information that was removed from the image during the first step.

7. The system of claim 1, wherein the processing system configured to train the visual generative model to transform the fourth state is further configured to:
train the visual generative model to determine contextual relationships and semantic dependencies between different parts of the image via masked reconstruction.

8. The system of claim 7, wherein the processing system configured to train the visual generative model to transform the fourth state is further configured to:
train the visual generative model to edit a specific part of the image based on a text prompt.

9. The system of claim 1, wherein the image comprises a video frame.

10. A method for composite continuous discrete diffusion, the method comprising:
applying noise, in a first step, to a first state of an image to generate a second state of the image, wherein the first state of the image comprises a clean state and the second state comprises a noisy state;
performing, in a second step, a stochastic transition from the second state of the image to a third state, including selective application of a mask to one or more regions of the second state of the image, wherein the third state comprises a masked state;
continuously repeating the first step and the second step at different time instances to generate a fourth state of the image, wherein the first step is repeated with intermediate states and with increased variance over time and wherein the fourth state comprises a final corrupted state of the image; and
training a visual generative model to transform the fourth state of the image back to the first state of the image with a denoising score matching objective and an iterative generation process within a diffusion probabilistic modeling framework.

11. The method of claim 10, the method further comprising:
compressing the image into a discrete or continuous latent space prior to applying the noise.

12. The method of claim 11, wherein compressing the image into the discrete or continuous latent space further comprises:
compressing the image into the discrete or continuous latent space using a variational autoencoder.

13. The method of claim 10, wherein selective application of the mask further comprises:
determining, for each pixel in an intermediate noisy state, whether to mask the corresponding pixel or keep original value of the pixel based on the mask.

14. The method of claim 10, wherein training the visual generative model to transform the fourth state further comprises:
training the visual generative model to transform the fourth state of the image to a less noisy state and less masked state of the image.

15. The method of claim 14, wherein training the visual generative model to transform the fourth state of the image to the less noisy state and less masked state of the image further comprises:
training the visual generative model to recover information that was removed from the image during the first step.

16. The method of claim 10, wherein training the visual generative model to transform the fourth state further comprises:
training the visual generative model to determine contextual relationships and semantic dependencies between different parts of the image via masked reconstruction.

17. The method of claim 16, wherein training the visual generative model to transform the fourth state further comprises:
training the visual generative model to edit a specific part of the image based on a text prompt.

18. The method of claim 10, wherein the image comprises a video frame.

19. A device for image editing, the device comprising:
one or more memories configured to store one or more images; and
processing circuitry coupled to the one or more memories and configured to perform image editing tasks, wherein to perform the image editing tasks, the processing circuitry is configured to:
obtain a prompt and an image; and
edit the image based on the prompt using a trained visual generative model, wherein the visual generative model is trained using composite continuous discrete diffusion.

20. The device of claim 19, wherein the visual generative model is trained according to the following:
apply noise, in a first step, to a first state of a training image to generate a second state of the training image, wherein the first state of the training image comprises a clean state and the second state comprises a noisy state;
perform, in a second step, a stochastic transition from the second state of the training image to a third state, including selective application of a mask to one or more regions of the second state of the training image, wherein the third state comprises a masked state;
continuously repeat the first step and the second step at different time instances to generate a fourth state of the training image, wherein the first step is repeated with intermediate states and with increased variance over time and wherein the fourth state comprises a final corrupted state of the training image; and
train the visual generative model to transform the fourth state of the training image back to the first state of the training image with a denoising score matching objective and an iterative generation process within a diffusion probabilistic modeling framework.
